(19) United States
(12) Patent Application Publication
(10) Pub. No.: US 2025/0390064 A1
(43) Pub. Date: Dec. 25, 2025

(54) CERAMIC HOROLOGY OR JEWELLERY COMPONENT

(71) Applicant: Comadur SA, Le Locle (CH)

(72) Inventors: Pierry VUILLE, Les Emibois (CH); Julien BOUCHET, Liebsdorf (FR)

(73) Assignee: Comadur SA, Le Locle (CH)

(21) Appl. No.: 19/220,410

(22) Filed: May 28, 2025

(30) Foreign Application Priority Data
Jun. 19, 2024 (EP) EP24183189.0

(51) Int. Cl. G04B 37/22; A44C 27/00; G04B 27/00; G04B 39/00

(52) U.S. Cl. CPC G04B 37/22; A44C 27/001; G04B 39/002; G04B 27/002

(57) ABSTRACT

A horology or jewellery component, characterised in that it contains γ phase silicon nitride in a percentage by volume comprised between 99% and 100%.

### CROSS REFERENCE TO RELATED APPLICATIONS

This application is claims priority to European Patent Application No. 24183189.0, filed on Jun. 19, 2024, the disclosures of which are incorporated by reference herein their entireties

### TECHNICAL FIELD OF THE INVENTION

The present invention relates to a horology or jewellery component made of a transparent ceramic material with a high degree of hardness.

### TECHNOLOGICAL BACKGROUND

The various horology components are currently made from the materials listed below. Watch bezels are generally made from ceramic materials such as zirconium oxide, aluminium alloys or steel. The glass is usually made of sapphire and the horology stones are generally rubies. The middles, buttons and crowns are generally made of metal alloys, such as stainless steel or titanium, or of ceramics. Silicon nitride is one such ceramic. The silicon nitride used in horology components is in the α phase, which is a trigonal phase, or in the β phase, which is a hexagonal phase, both of which have a hardness of between 1,500 HV and 1,600 HV.

In general, the aforementioned materials have hardnesses of up to 1,600 HV for ceramics and up to 2,000 HV for ruby. It is difficult to achieve hardness values higher than these, which limits the ability to reduce the scratchability of external horology components such as buttons and bezels.

Nowadays, there is a high demand for materials with hardness values higher than these, as higher hardness results in reduced scratchability and also reduced wear and degradation.

### SUMMARY OF THE INVENTION

The present invention aims to provide a horology or jewellery component made from a material with a hardness greater than or equal to 3,000 HV in order to increase its resistance to wear, scratching and, more generally, degradation.

To this end, it is proposed to make a horology or jewellery component from silicon nitride with a γ phase, which is a cubic phase, rather than an α or β phase as is currently used in horology components. In the γ-phase, silicon nitride has exceptional hardness, reaching up to 3,500 HV. The hardness of the component is therefore 2.3 times greater relative to conventional ceramics. For external use, middles, bezels, crowns and buttons made from this material offer unique scratch resistance. This material is also transparent. The transparency of this material makes it particularly attractive for making glass with exceptional scratch resistance. For internal use, horology stones, to name but one example, made from this material are 1.75 times harder than rubies, which are generally used for this application. Moreover, initial research suggests that the use of silicon from silicon nitride makes it possible to obtain lubricant-free movements. This material is likely to have good tribological properties, leading to the development of maintenance-free movements. Improving tribological properties would help lower the coefficient of friction between components in dry or lubricated contact, thereby reducing the wear on internal components.

More specifically, the present invention relates to a horology or jewellery component, characterised in that it contains γ phase silicon nitride in a percentage by volume comprised between 99% and 100%.

More specifically, the present invention relates to a horology or jewellery component, characterised in that it consists of γ-phase silicon nitride in a percentage by volume comprised between 99% and 100% with, optionally, a percentage by volume less than or equal to 1% of α and/or β phase silicon nitride and/or of impurities.

### DETAILED DESCRIPTION OF THE INVENTION

The present invention relates to a horology or jewellery component made of y phase silicon nitride (Si₃N₄). In the field of horology, this can be an external part such as the middle, back, bezel, button, crown, valve, wristlet link, dial, hand, dial index, etc. It can also be a movement component such as a horology stone.

This γ-phase silicon nitride component has a hardness greater than or equal to 3,000 HV, and can reach up to 3,500 HV.

The component is made from a powder or from a powder blend. For example, this can be the commercial powder SN-E10, by Ube Industries, Ltd., Ube, Japan. The powder blend can consist of 20% α-Si₃N₄ and 80% β-Si₃N₄ or 100% β-Si₃N₄. Sintering is done in MAP (MultiAnvil Press) equipment; the press can be of the KAWAI type. This press makes it possible to apply extreme pressures of up to 45 GPa using anvil assemblies that apply force to encapsulated powder. The capsule can be made of platinum. Sintering is carried out at a temperature comprised between 1,600°° C. and 1,900°° C., preferably between 1,650° C. and 1,850° C., at a dwell time ranging from twenty minutes to sixty minutes under a pressure greater than or equal to 10 GPa, preferably greater than or equal to 15 GPa. The achievable pressure will be greater for smaller components, making it particularly suitable for making buttons, crowns and horology stones.

Preferentially, the component obtained is composed of 100% by volume of γ-phase Si₃N₄. However, it cannot be ruled out that a fraction of less than or equal to 1% by volume of α and/or β phase Si₃N₄ may be present, the presence of the different phases being quantified by X-ray diffraction in accordance with standard NF EN 13925. This fraction of less than or equal to 1% could also comprise impurities such as Na, Ca, P, Fe, Ni, Cl.

The component has a hardness comprised between 3,000 HV and 3,500 HV measured in accordance with ISO 14705:2016. Another feature is that it is transparent.

1. A horology or jewellery component, comprising γ phase silicon nitride in a percentage by volume comprised between 99% and 100%.

2. The horology or jewellery component according to claim 1, wherein the component has an HV hardness comprised between 3,000 and 3,500.

3. The horology or jewellery component according to claim 1, wherein the component is an external part or a movement component.

4. The horology or jewellery component according to the claim 1, wherein the component is a button, a crown or a horology stone.

5. The horology or jewellery component according to claim 3, wherein the component is a glass.
